(19) United States
(12) Patent Application Publication
(10) Pub. No.: US 2022/0072637 A1
(43) Pub. Date: Mar. 10, 2022

(54) A GUIDE FOR A CUTTING TOOL

(71) Applicant: B-EAMES CUTTING GUIDE LIMITED, Liss Hampshire (GB)

(72) Inventor: James Alen EAMES, Liss Hampshire (GB)

(21) Appl. No.: 17/423,396

(22) PCT Filed: Jan. 15, 2020
(86) PCT No.: PCT/IB2020/050307

§ 371 Date: Jul. 15, 2021

(30) Foreign Application Priority Data
Jan. 15, 2019 (GB) 1900550.3

(51) Int. Cl. B23D 59/00; B27G 19/04

(52) U.S. Cl. CPC B23D 59/003; B27G 19/04

(57) ABSTRACT

A guide for a cutting tool. The guide comprises a plate and an attachment means for attaching the plate to the cutting tool.

The guide is removably attached to a circular cutter and comprises: a reflector plate for reflecting a laser and an attachment means for attaching the reflector plate to the circular cutter. On the reflector plate there is formed at least one linear marking which when aligned with a projected line from the laser enables the cutter to be positioned so as to locate its blade in a plane defined by the laser.

An adjustable connector attaches the guide to the circular cutter.

### FIELD OF THE INVENTION

The present invention relates to a guide for a cutting tool, more specifically the present invention relates to a guide for a cutting tool such as a circular saw for use with a line laser.

### BACKGROUND TO THE INVENTION

In use, cutting tools, such as circular saws and grinders, have to be aligned with a line which is to be cut, usually by eye, or by running the saw and grinder along a physical object placed parallel and adjacent a line to be cut.

This is sometimes difficult as dust and cuttings can obscure a line. Sometimes water that cools a cutting blade washes away lines drawn on the ground with chalk or pencil.

Over the last decade or so laser levels and laser guides have become cheaper and more readily available and these project a beam, in a plane, which when incident on a floor, wall, ceiling or worktop, presents a line along which a cut is to be made in order to guide the cutter.

### Prior Art

German patent application DE 3 839 044 (Flier) discloses a cutting device and guide for measuring a cut without the aid of cut identification lines. The cutting device is speeds up cutting.

UK patent application GB 2 292 541 (Baker Brown) discloses a sight for use with a hand-guided power tool to assist in following a guide line on the surface of a workpiece to be cut. The sight includes an arm which, in use, extends downwardly in front of a leading end of the tool towards a sighting head for visual alignment with a guide line on the workpiece. The sight head and arm are formed from a flat strip. The arm is bent into a shallow V. The sight is attached to the tool by way of hook and loop connectors.

UK patent application 2 464 205 (Robert Bosch) discloses a monitoring device for monitoring a workpiece to be machined. The device comprises a monitoring plate that extends in the machining direction and an illuminating unit arranged on the monitoring plate. The power tool is preferably hand held for example a saw. The plate may have a scale on one side and may have a reflective coating on one side or may be transparent to direct light from a light emitting diode (LED) towards the workpiece.

US patent application US 2005/0160607 (Petrenko) discloses a power saw having one or more features for facilitating straight line and/or angled cuts, including at least two sets of non-slip wheels connected to a bottom plate. Each set of wheels comprises an axle having at least two wheels that are fixed to rotate at the same rate as the axle. A transparent guide is attached to a front part of a base plate that includes a straight line marking aligned with the saw blade for alignment with a marking on a workpiece.

An aim of the present invention is to provide a guide for aligning a circular saw or a grinder with a line laser, so as to facilitate the making of desired cuts.

### SUMMARY OF THE INVENTION

According to a first aspect of the present invention there is provided a guide for a circular cutter, such as a circular saw, the guide comprising: a reflector plate for reflecting a laser and an attachment means for attaching the plate to the circular saw, on the reflector plate there is formed at least one linear marking which when aligned with a projected line from the laser, is positioned so as to locate a blade of the circular cutter in a plane defined by the laser; and an adjustable connector attaches the guide to the circular cutter.

Because the connector that attaches the guide to the circular cutter is adjustable, the user is able to position the reflector plate in precisely the correct configuration in order to enable precise alignment of a linear marking with the blade, so that at least one linear marking is coplanar with the blade.

Ideally the at least one linear marking is on a face of the reflector plate that faces away from the blade, so that when viewed from above the user is able to align the marking with the blade.

Ideally the laser is a self-levelling type so that it always automatically finds and maintains a level within a specified range. Unlike normal laser levels, a self-levelling laser has an internal pendulum that automatically levels the laser thereby always ensures accuracy.

In use, the guide is attached to the circular saw by the attachment means and one of the at least one linear markings on the plate is aligned with a line laser before and during a cut is made using the tool. The circular saw, and the cut made thereby, are therefore able to be oriented at a desired angle with respect to the line laser which enables a cut to be made parallel to the plane of a line laser or at a selected angle with respect to the plane of the line laser.

Line lasers are lasers which emit a thin plane beam instead of a point beam, and as such produce a line when shone onto a surface rather than a point. Line lasers are commonly used in laser line levels which project a horizontal line laser and/or a vertical line laser for facilitating the alignment of other objects.

The plate is preferably a flat plate and is substantially planar. Ideally it is generally substantially rectangular. Preferably the plate is formed from a metal such as aluminium or stainless steel.

The plate preferably comprises a first face upon which the one or more linear markings are located. Markings may be printed, engraved, cut or etched on the marked face. The marked face preferably faces away from the circular saw in use.

In some embodiments, the attachment means is provided or supported, at one end of the plate.

The attachment means may be for permanently attaching the plate to a circular saw, or may be for removably or releasably attaching the plate to a circular saw.

Ideally the attachment means includes at least two, and ideally four, adjustable connectors, such as screw threaded adjusters with a head that contacts a hard outer protective body of the circular cutter.

The attachment means may adapted for attaching the reflector plate to a handle, body, support, casing or blade shroud of the circular saw and optionally of another cutting tool.

The attachment means may also be used to attach the reflector plate to an electric power saw.

In some embodiments the attachment means may be adapted for attaching the reflector plate to a specific circular saw, to a specific model of circular saw or to one or more bespoke circular saws comprising one or more elements for engaging with the attachment means.

In other embodiments, the attachment means may be for attaching the plate to a range of different suitable circular saws or to any circular saw within a range of suitable dimensions.

Optionally mountings may provide in the casing of a particular type of circular saw for receiving threaded adjusters to which the reflector plate is connected so that two, three or preferably four adjustable cutters

The attachment means is preferably for mounting the plate on the circular saw, and/or preferably attaches the plate to the circular saw such that it is not able to move or rotate with respect to the circular saw or the blade thereof.

The attachment means spaces the plate apart from the circular saw and/or the blade thereof. For example, the attachment means may comprise one or more spacers, struts or other supporting elements which in use are arranged intermediate the plate and the circular saw.

The attachment means may comprise one or more clamps, clips, bolts, screws, and/or elements shaped to fit into, onto, or around elements of the circular saw.

In some embodiments the attachment means may attach the plate in replacement of an element of the circular saw, for example, in some embodiments the attachment means may be for attaching the plate in replacement of a portion of the exterior of the housing of a circular saw.

There is one or more linear markings for aligning with a line laser in use are on the plate. The linear markings are preferably on a face of the plate which is arranged facing away from the blade of the circular saw to which it is attached in use.

In some embodiments, the guide may comprise a single linear marking on the plate for aligning with a line laser.

In such embodiments, the plate is attached to the circular saw such that the single linear marking is coplanar with the blade of the circular saw (or with the cutting element of another cutting tool to which the guide is attached, such as the blade edge, wire, chain, waterjet, or laser of the cutting tool). For example, the plate may be attachable, only attachable, or permanently attached to a circular saw such that the single linear marking is coplanar with the blade of the circular saw.

In preferred embodiments, the guide may comprise a plurality of linear markings on the plate for aligning with a laser line in use.

In such embodiments, the plate is attached to the circular saw such that at least one of the linear markings is coplanar with the blade of the circular saw (such as the blade edge, wire, chain, waterjet, or laser of the circular saw). For example, the plate may be attachable, only attachable, or permanently attached to a circular saw such that at least one of the linear markings is coplanar with the cutting element of the circular saw.

In embodiments where the plate is attached such that one or more of the one or more linear markings on the plate is coplanar with the blade of the circular saw, the plate is preferably also attached to the circular saw such that the plate is substantially orthogonal to the plane containing the cutting edge and the coplanar linear marking. For example, the plate may be attachable, only attachable, or permanently attached to a circular saw such that the plate is substantially orthogonal to a plane containing at least one of the linear markings and the blade of the circular saw.

In arrangements where the plate is substantially orthogonal to a plane containing at least one of the linear markings and the blade of the circular saw, if a line laser substantially orthogonal to the plate is aligned with the linear marking coplanar with the blade of the circular saw, the cutting element will be substantially coplanar with the line laser. Therefore, the blade will remain aligned with the line laser as long as the linear marking remains aligned with the line laser and the plate remains orthogonal to the line laser.

One, some or each of the linear markings may be elongate linear grooves in, slots through, or markings on the surface of the plate. Alternatively, or additionally, one, some or all of the linear markings may be a plurality of marks in a straight line. Such marks may be points (such as point marks on the surface of, point indents in the surface of, or holes through the plate), or may be lines (such as linear marks on the surface of, linear grooves in the surface of, or linear slots through the plate) which are preferably aligned with the straight line that they are in. Separate marks of the same linear marking may be labelled, for example, individual marks may be labelled with the angle that their linear marking is at with respect to the plane containing the blade of the circular saw and substantially orthogonal to the plate.

For example, one, some, or all of the one or more linear markings may comprise at least a pair of marks at opposite edges of the plate (and/or a face thereof). In use, the circular saw and by extension the plate may be arranged such that the line laser is incident upon both of the marks of a pair and the line laser is therefore aligned with the linear marking.

In embodiments comprising a plurality of linear markings, some or all of the linear markings may be parallel to each other. Alternatively, or additionally, some or all of the linear markings may be at acute, right or obtuse angles with respect to each other.

In preferred embodiments, the guide comprises a first linear marking which is coplanar with the blade of the circular saw when the plate is attached to the circular saw (as described above) and a plurality of other linear markings at acute, right or obtuse angles to the first linear marking. Such markings are preferably coplanar with each other and the first linear marking on the plane of the plate.

The plurality of other linear markings at acute, right or obtuse angles may each intersect each other and the first linear marking (or if they are linear markings comprising multiple marks in a straight line, their lines may intersect each other and the line of the first linear marking) at a single point, which may be the centre of the plate. In such embodiments, the angular separation between some or all of the adjacent linear markings may be constant. For example, some or all of the linear markings which intersect at a common point may be at 5, 10, 15 or 20 degrees to the closest other linear markings.

Alternatively, or additionally, one, some, or all of the plurality of linear markings may be parallel to each other and separated by constant distances.

In use, the guide may be used with and attached to a circular saw such as a saw, knife, laser cutter, chisel, chainsaw, waterjet cutter, or any other circular saw. In preferred embodiments the guide is for use with a circular saw. The plate is preferably attached to or mounted on the body of the circular saw with at least one of the one or more linear markings coplanar with the saw disc.

According to a second aspect of the present invention, there is provided a circular saw with a guide according to the first aspect of the invention demountably connected thereto.

Preferred embodiments of the invention will now be described, by way of examples, with reference to the figures.

### BRIEF DESCRIPTION OF THE FIGURES

FIG. 1 is a first overall view of a guide according to the present invention mounted on a visually disclaimed circular saw;

FIG. 2 is a second overall view of the guide of FIG. 1 mounted on the visually disclaimed circular saw;

FIG. 3 is an overall view of the guide of FIG. 1 mounted on the circular saw with a line laser incident thereon;

FIG. 4 is a face-on view of a first variant plate for a guide according to the present invention;

FIG. 5 is a face-on view of a second variant plate for a guide according to the present invention;

FIG. 6A shows a side elevation of a further example of an adjustable removable guide for a circular cutter, such as a grinder and shows a reflector plate laser and an attachment means;

FIG. 6B is a front elevation of the embodiment shown in FIG. 6A and shows the reflector and the linear marking thereon;

FIGS. 7A and 7B show overall isometric views of the adjustable removable guide of FIGS. 6A and 6B, depicting an arcuate cover;

FIGS. 8A to 8J depict various views of the adjustable removable guide positioned and locked in a range of different orientations; and

FIG. 9 illustrates a plan view of a preferred embodiment of the adjustable removable guide and shows the reflector plate and four separately adjustable attachment devices.

### DETAILED DESCRIPTION OF THE FIGURES

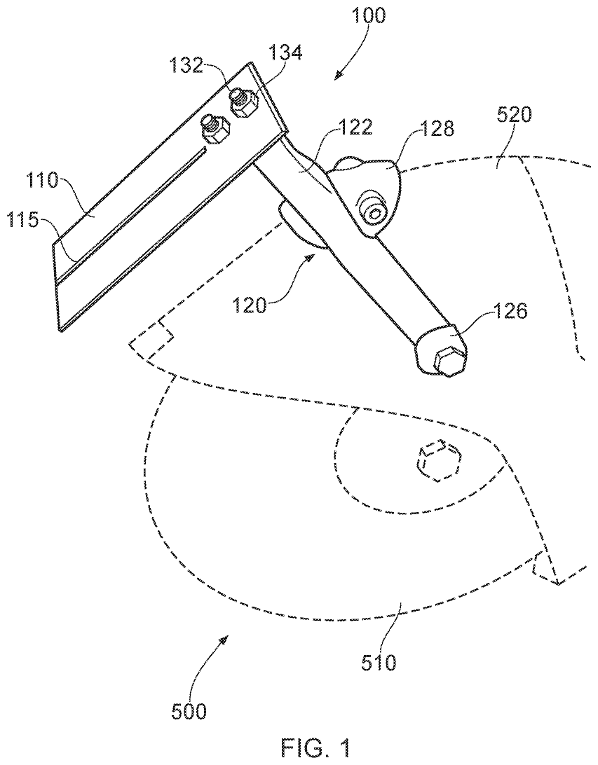

FIGS. 1 to 3 show a guide 100 according to the present invention mounted on a circular saw 500. The guide 100 comprises a plate 110 with a singular linear marking 115 thereon, and an attachment means 120 for mounting the guide 100 on the blade shroud or cover 520 of the circular saw 500 and securing it thereto.

The plate 100 is a flat rectangular metal plate 110 with a single linear marking 115 on one of its faces. The linear marking 115 extends from the centre of one of the short edges of the plate 110, along the centre of the plate, equidistant between the two longer lateral edges of the plate 110, for approximately three quarters along the length of the plate 110.

A pair of apertures are formed through the plate 110 between the end of the linear marking 115 and the short edge of the plate 110 to which the linear marking does not extend. The two apertures are aligned with the linear marking 115. In use, threaded ends of a U-shaped bolt 132 of a saddle clamp 130, comprised by the attachment means 120, extend through the apertures. Nuts 134 are screwed onto each of the bolts 132 so as to secure the plate 110 onto the bracket 122 of the attachment means 120.

The attachment means 120 comprises a bracket 122 and a saddle clamp 130. The bracket is generally A-shaped and comprises two elongate limbs each with a first end 124 which is connected to the first end 124 of the other limb, and a second end 126 which is connected to the side of the blade shroud 520 of the circular saw 500 in use.

The first ends 124 are interconnected by a curved length of bracket (to which the plate 110 is secured by the saddle clamp 130) and central points of the limbs are interconnected by a central moulded brace 128 which fits onto the edge of the blade shroud 520 of the circular saw 500.

The second ends 126 of the limbs, and a central moulded brace 128, are both connected to the blade shroud 520 of the circular saw 500 by bolts.

The saddle clamp 130 comprises a U-shaped bolt 132 and a moulded saddle block 136. The saddle block 136 fits onto the curved interconnected first ends 124 of the limbs of the bracket 122 and defines a flat surface against which the plate 110 is secured by the U-shaped bolt 132 and nuts 134. The saddle block 136 having two apertures formed therethrough, through which the U-shaped bolt 132 fits in use, such that the curved interconnected first ends 124 of the limbs of the bracket 122 can be clamped tightly between the U-shaped bolt 132 and the saddle block 136 so as to lock the guide in a selected position.

The orientation of the plate 110 is fixed with respect to the saddle block 136 due to the U-shaped bolt 132 having two ends which are received by apertures aligned with linear marking 115. As the saddle block 136 is moulded such that it fits onto the curved interconnected first ends 124 of the limbs of the bracket 122, the orientation of the plate 110, with respect to the blade of a grinder or the circular saw 500, is fixed in use. The plate 110 is connected to the circular saw 500 such that the linear marking 115 is coplanar with the circular saw blade 510, and the plate itself is orthogonal to that shared plane.

As such, when the linear marking 115 is aligned with plane of a line laser which is orthogonal to the plate 110, such that the line laser shines along the linear marking 115, the circular saw blade 510 is always located within the plane defined by the line laser.

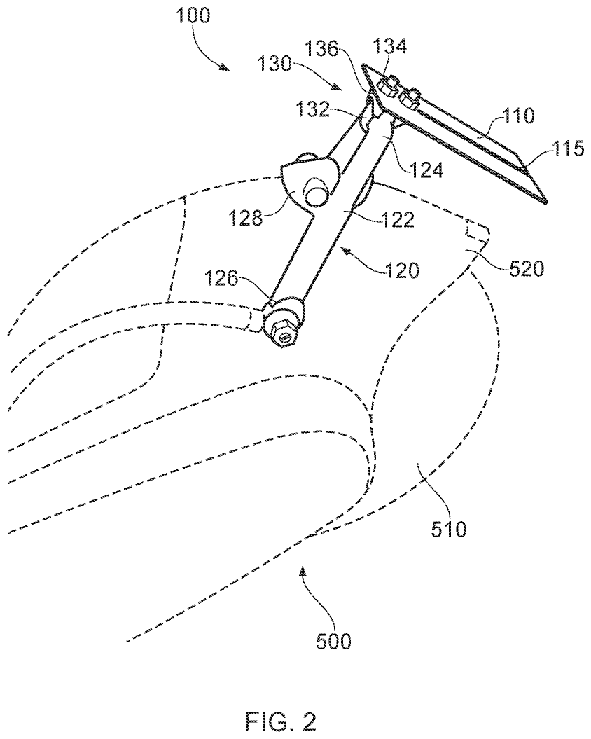

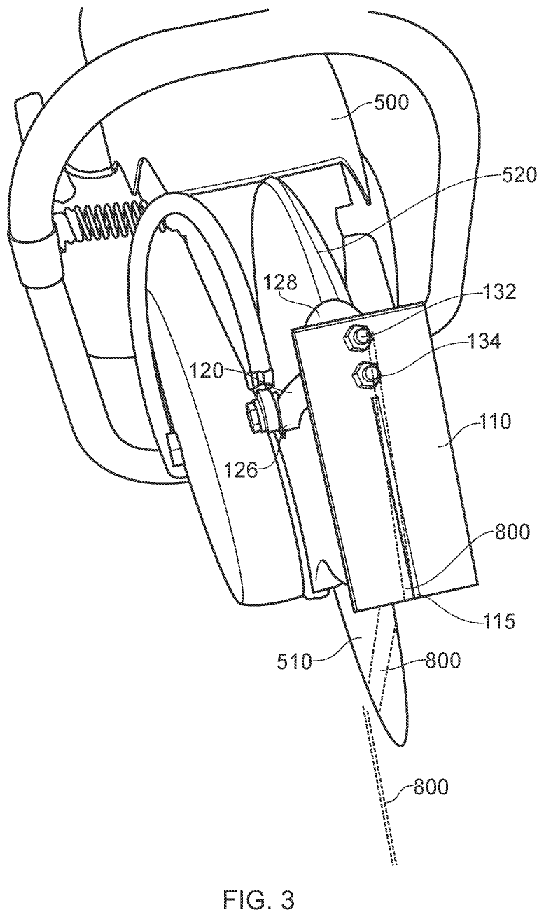

FIGS. 1 and 2 show the guide 100 mounted on the circular saw 500 with the circular saw marked in ghost lines. FIG. 3 shows the guide 100 mounted on the circular saw 500 with the laser 800 of a line laser such as a line laser level incident thereon, the laser 800 is slightly misaligned with the circular saw 500 and the guide, such that there is a small angle between the laser 800 incident on a reflector plate 110 and the linear marking 115.

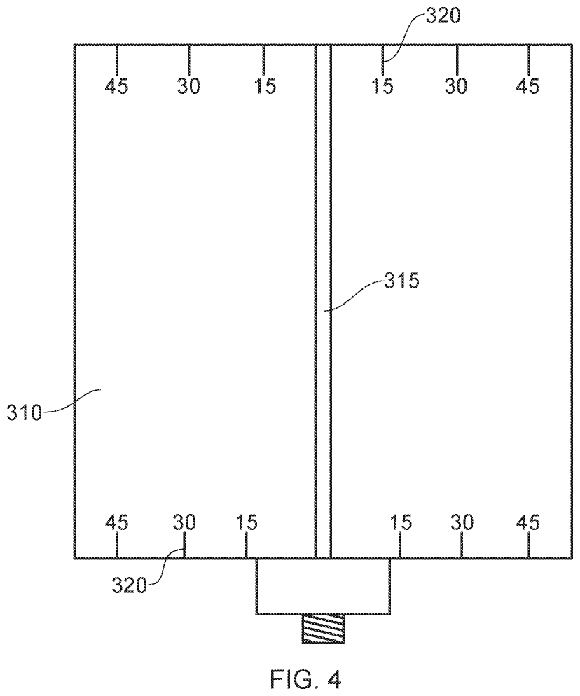

FIG. 4 shows a version of the reflector plate 310 for a circular saw according to the present invention. The reflector plate 310 is a substantially rectangular metal plate with a plurality of linear markings thereon. The first of the linear markings is a central linear marking 315 in the form of a continuous line between the centres of the two short edges of the reflector plate 310. The remaining six linear markings each comprise a pair of marks 320 at opposite short edges of the reflector plate 310 and on opposite sides of the central linear marking 315. Each pair of marks 320 is labelled with the number of degrees the line it defines with the other mark 320 of its pair is at with respect to the central linear marking 315. Therefore each linear marking may be identified by aligning a first of the marks 320 with the mark 320 labelled with the same number as the first mark 320 on the opposite side of the central marking 315 and at the opposite short edge of the reflector plate 310.

The six additional linear markings defined by the marks 320 are at fifteen, thirty and forty-five degrees to each side of the central linear marking 315.

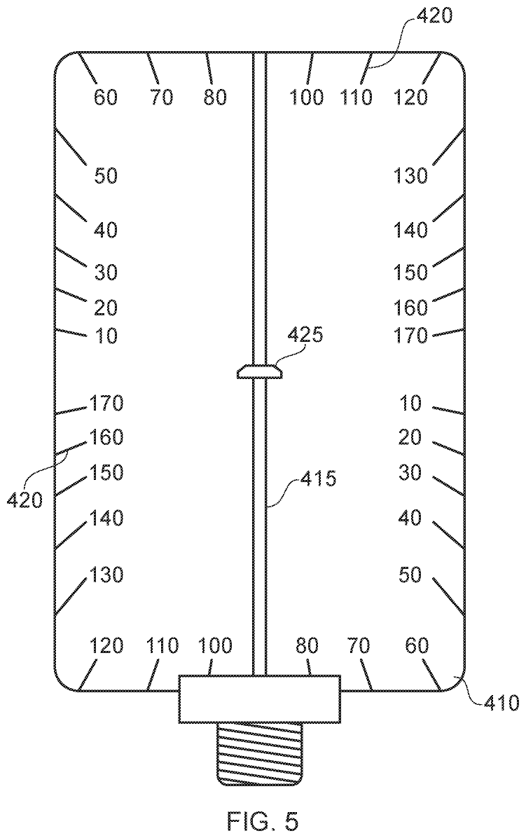

FIG. 5 shows a second variant of a reflector plate 410 for a circular saw according to the present invention. The reflector plate 310 is a substantially rectangular plate with a plurality of linear markings thereon.

In a similar manner to the reflector plate 310 shown in FIG. 4, the reflector plate 410 comprises a central linear marking in the form of a continuous line between the centres of the two short edges of the reflector plate 410 as well as a plurality of additional linear markings defined by pairs of corresponding marks 420 on opposite edges of the reflector plate 410.

Each pair of marks 420 comprises one mark on each side of the central linear marking 415 and is formed on opposite short edges or opposite long edges of the reflector plate 410. Each pair of linear marks 420 defining a line therebetween passing through the midpoint of the central linear marking 415.

A short linear marking 425 at right angles to the central linear marking 415 bisects the linear marking at its midpoint, such that the intersection of this linear marking 425 with the first linear marking 425 marks the centre of the reflector plate 410.

Each mark 420 of each pair of marks 420 is labelled with the number of degrees the line it defines with the other mark 420 of its pair is at with respect to the short linear marking 425. Therefor each linear marking may be identified by aligning a first of the marks 420 with the mark 420 labelled with the same number as the first mark 420 on the opposite side of the central marking 415 and at the opposite edge of the reflector plate 410.

The additional linear markings defined by the labelled marks 420 on the edge of the reflector plate are at 10, 20, 30, 40, 50, 60, 70, 80, 100, 110, 120, 130, 140, 150, 160, and 170 degrees to the short linear mark 425 at right angles to the central linear marking 410.

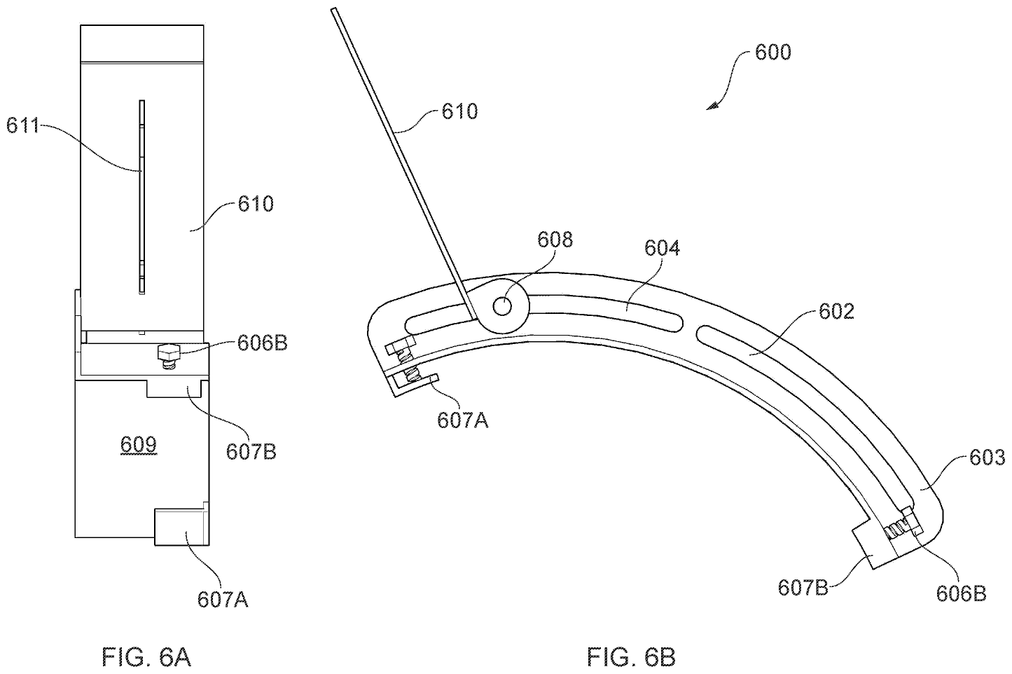

Referring now to FIGS. 6A and 6B there is shown FIG. 6A shows a side elevation of a further example of an adjustable removable guide 600 for use with a rotary cutter or grinder. There is shown a reflector plate 610 for reflecting a laser and an attachment means 608 connects the reflector plate 610 to a curved support body 603 of the guide which itself is demountably attached to a circular saw (not shown) as described below.

On the reflector plate 610 there is formed at least one linear marking 611 which when aligned with a projected line from the laser (not shown), is positioned so as to locate the blade (not shown) in a plane defined by the laser. Adjustable connectors 606A and 606B together attach the body 603 of the guide to the circular cutter. End stops 607A and 607B help to locate and retain the adjustable connectors 606A and 606B on the circular cutter.

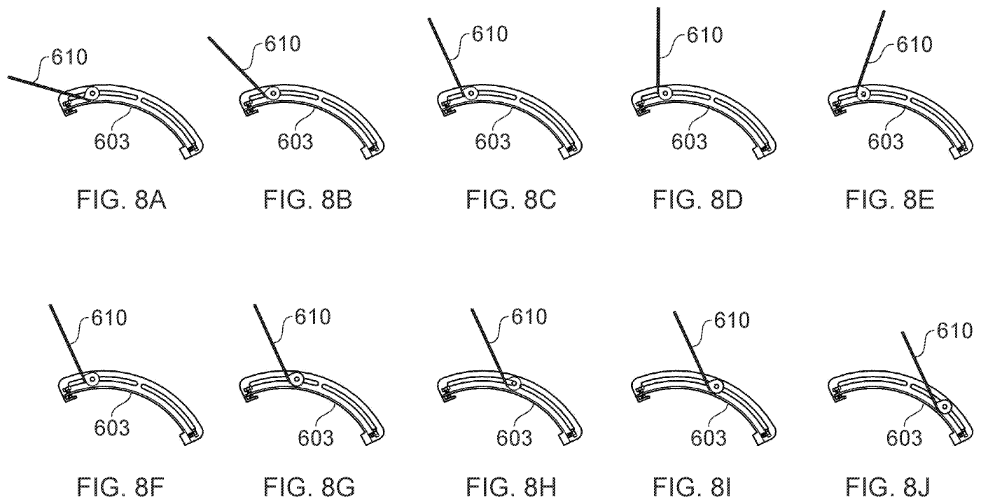

Slots 602 and 604 enable the reflector plate 610 to be positioned in a range of different positions and orientations to suit the user and the nature of what is being cut. Some of these positions and orientations are depicted in FIGS. 8A to 8J which together show various views of the adjustable removable guide with the reflector plate 610 positioned and locked in a range of different orientations.

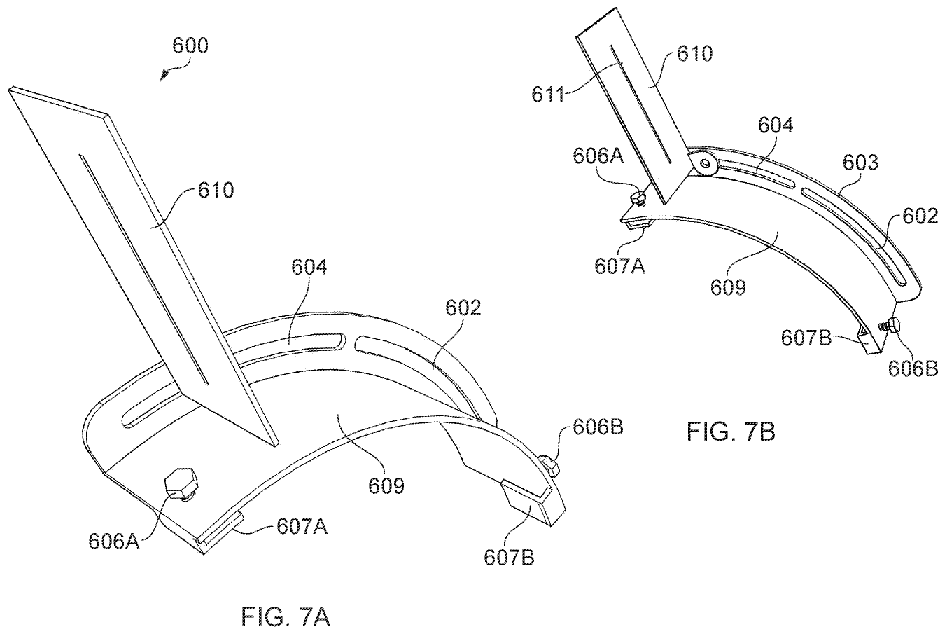

FIGS. 7A and 7B show overall isometric views of the adjustable removable guide of FIGS. 6A and 6B and show in greater detail the arcuate cover;

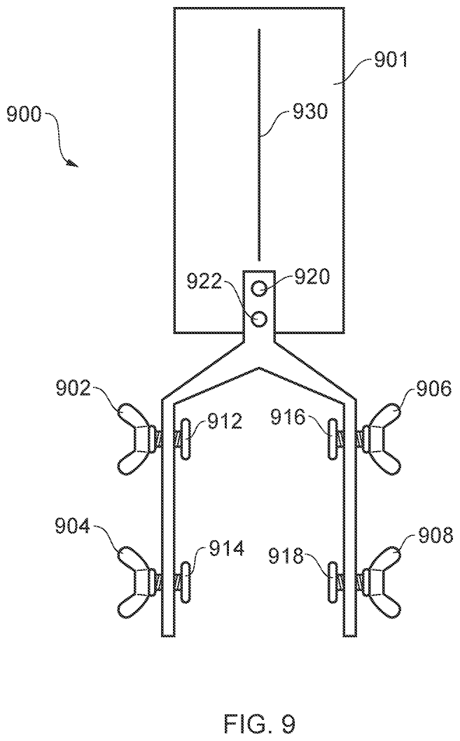

Referring to FIG. 9 there is shown a preferred embodiment of a guide 900 for use with a circular cutter, such as a circular saw (not shown). The guide 900 comprises: a reflector plate 901 for reflecting a laser line (not shown) and four attachment means 902, 904, 906 and 908 which are threaded shaft with rubber feet 912, 914, 916 and 908 restively.

FIG. 9 illustrates a particularly preferred embodiment of the adjustable removable guide 900 and shows a body which has a ‘wishbone’ or ‘tuning fork’ shape with two limbs joined together. Two bolts are provided in each of the two limbs. The two limbs are connected to a reflector plate 901 by way of connectors 920 and 922.

Four separate attachment means 902, 904, 906 and 908, which are threaded and have ‘butterfly’ nuts or wingnuts, are supported in each of the limbs: two each on each limb arranged substantially diametrically opposed one to another.

A wingnut or butterfly nut is a type of nut with two larger metal “wings”, one on each side, so as to enable them to tightened and loosened by hand without tools.

The attachment means 902, 904, 906 and 908 enable users to attach and remove the guide 900 and importantly adjust its so that linear marker 930 can be easily aligned to be in the same plane as the cutting blade (not shown).

The reflector plate 901 is positioned so as to locate a blade of the circular cutter in a plane defined by the laser. In addition to the four separate attachment means 902, 904, 906 and 908, there may be an adjustable connector that attaches the reflector plate 901 to the two limbs, a saddle clamp may be connected by way of connectors 920 and 922. The connectors 920 and 922 may comprises a U-shaped bolt (not shown) and a moulded saddle block (not shown) in a similar manner to the arrangement shown in FIGS. 1 and 2.

The invention has been described by way of example only and it will be appreciated that variation to the above-described embodiments may be made without departing from the scope of the invention as defined by the claims.

Variation may be made to aforementioned embodiments for example by forming a slot or series of slots, perforations, holes or apertures in the reflector plate as the linear marking. Such an arrangement also allows the user to see through the slot onto a floor or work surface as well as view the reflector plate from above.

1. A guide for a circular cutter, the guide comprising:
a reflector plate for reflecting a laser and an attachment means for attaching the reflector plate to the circular saw, on the reflector plate there is formed at least one linear marking which when aligned with a projected line from the laser, is positioned so as to locate a blade of the circular cutter in a plane defined by the laser; and
an adjustable connector enables the reflector plate to be adjusted through a range of angles, in the plane of the blade, so as to enable the reflector plate to be oriented at a desired angle with respect to a line laser.

2. The guide according to claim 1 wherein the reflector plate is flat and substantially planar.

3. The guide according to claim 1 wherein the reflector plate is substantially rectangular.

4. The guide according to claim 1, wherein linear markings are defined on the reflector plate and are positioned at angles one to another on a face of the plate which in use faces away from the blade.

5. The guide according to claim 4 wherein the linear markings comprise a pair of marks at opposite edges of the reflector plate.

6. The guide according to claim 1 wherein the attachment means is adapted to connect the reflector plate to a body or shroud of a circular cutter, such as a circular saw.

7. (canceled)

8. The guide according to claim 7 wherein the adjuster adjustable connector is supported in an arcuate slot or groove and is movable and lockable with respect to the slot or groove.

9. The guide according to claim 1 wherein the attachment means is supported by a body that is connected to one end of the reflector plate.

10. The guide according to claim 9 wherein bolts are supported by the body, the bolts, act as attachment means for releasably attaching the reflector plate to the circular cutter.

11. The guide according to claim 10 wherein the body supports at least two, and ideally four, adjustable connectors, such as screw threaded adjusters with a head that contacts a hard outer protective body or shroud of the circular cutter.

12. The guide according to claim 11 wherein the screw threaded adjusters have wingnuts or butterfly nuts.

13. The guide according to claim 10 wherein rubber feet are provided at the end of the connectors for gripping the body or shroud of the circular cutter.

14. The guide according to claim 9 wherein the body has a ‘wishbone’ or ‘tuning fork’ shape and a bolt is provided in each of the two limbs so as to enable adjustment of the adjustable connector.

15. The guide according to claim 1 wherein the attachment means includes a locking device that attaches the reflector plate to the circular cutter such that the reflector plate is not able to move or rotate with respect to the circular cutter.

16. The guide according to claim 1 wherein a spacer includes packing means or struts for spacing the reflector plate apart from the circular cutter and/or the blade thereof.

17. The guide according to claim 1 wherein the attachment means comprises one or more clamps shaped to fit into, onto, or around elements of the circular cutter.

18. The guide according to claim 1 wherein the attachment means is adapted to attach the reflector plate to a handle, body, support, casing or blade shroud of the circular cutter or circular saw.

19. The guide according to claim 1 wherein a series of slots, perforations, holes or apertures are provided in the reflector plate on the linear marking.

20. The guide according to claim 1 wherein the reflector plate is formed from a metal such as aluminium or stainless steel.

21. The circular cutter has a shroud or casing in which mountings are defined, the mountings are dimensioned and arranged to receive the attachment means according to claim 1.
